(19) United States
(12) Patent Application Publication
(10) Pub. No.: US 2009/0217703 A1
(43) Pub. Date: Sep. 3, 2009

(54) Process for Producing Glass Articles, in Particular Closure Elements Made of Glass, and Device, Installation and Use Thereof

(76) Inventor: Hermann Fueller, Riedlhuette (DE)

Correspondence Address: MICHAEL L. DUNN, SIMPSON & SIMPSON, PLLC, 5555 MAIN STREET, WILLIAMSVILLE, NY, 14221, US

(21) Appl. No.: 12/085,861

(22) PCT Filed: Nov. 29, 2006
(86) PCT No.: PCT/EP2006/011465

§ 371 Date: May 13, 2009

(30) Foreign Application Priority Data
Nov. 30, 2005 (DE) 10 2005 057 125.5

(51) Int. Cl. C03B 9/00

(52) U.S. Cl. 65/79; 65/78; 65/300

(57) ABSTRACT

The invention relates to a method of producing glass articles, especially closure bodies of glass such as, for example, glass stoppers, wherein the following steps are carried out:
a) introducing a portion unit of liquid or paste-like glass into a negative mould (10) of an article to be produced;
b) applying negative pressure to the negative mould (10) for a period which is sufficient for the liquid or paste-like glass to be sucked into the negative mould (10) and to be brought into exactly fitting contact with the walls of the negative mould (10);
c) cooling and de-moulding of the moulded glass article.

The invention further relates to an apparatus, to a plant and also to the use of the apparatus and plant in the production of glass articles.

### BACKGROUND OF THE INVENTION

The invention relates to a method of producing glass articles, to an apparatus for producing glass articles, and also to a plant for producing glass articles, and to the use of an afore-mentioned apparatus and/or plant, according to the preamble of one of claims 1, 10, 14 and 16.

The production of glass articles, especially closure bodies of glass such as, for example, glass stoppers, known for the purpose of closing bottles, is usually accomplished by means of a so-called injection method, wherein liquid glass material is injected into a closed casting mould, from the bottom or top thereof, to occupy the cavity of the mould. After cooling and solidification, the solidified glass thread has to be cut off at the inlet. In that method it has been found to be disadvantageous firstly that the cutting location, where the glass stopper has been separated from the glass thread, still has to be ground and polished after moulding. In addition, that type of production gives rise to left-over glass, which has to be removed or, possibly, recycled. To that extent the injection method for the production of glass articles is technically onerous and therefore expensive.

A further possibility for producing glass stoppers provided with a top part, for the closure of wine bottles, is described in DE 103 20 345 A1. In that case, molten glass is introduced and pressed into a negative mould of a stopper that is to be produced, an axially displaceable plunger being provided for the formation of a tolerance-compensating depression in the top part of the stopper. The method described therein is very onerous for the reason, amongst others, that the axially displaceable plunger for producing a stopper has to be positioned exactly above the top part of the stopper. It is then necessary for the plunger to act on the top part of the stopper with a defined pressure so that tolerances present in the mould therein can be compensated by the pressure exerted by the plunger. The plunger then has to be removed from the pressed-in depression in the top part of the stopper. Glass stoppers produced in such a way accordingly always have, disadvantageously, a depression in their top part. In addition, their production is time-consuming because of the pressing procedure that is necessary and the time requirement associated therewith. A further disadvantage moreover lies in the fact that the negative mould therein and also the plunger have to be cleaned regularly because the pressing pressure required gives rise to the concern that residues of glass will remain behind both on the plunger and in the negative mould.

The invention is based on the problem of making available a method and also an apparatus and plant, which provide a cost-efficient possibility for producing glass articles of different shape and geometry or surface formation, especially glass stoppers, and which moreover make it possible to avoid the afore-mentioned disadvantages.

### BRIEF SUMMARY OF THE INVENTION

The problem is solved by a method according to claim 1, by an apparatus according to claim 10, by a plant according to claim 14 and by the use of an apparatus and/or plant as mentioned before, according to claim 16.

The problem is solved especially by a method of producing glass articles, especially closure caps of glass such as, for example, glass stoppers, wherein the following steps are carried out:

a) introducing a portion unit of liquid or paste-like glass into a negative mould of an article to be produced;

b) applying negative pressure to the negative mould for a period which is sufficient for the liquid or paste-like glass to be sucked into the negative mould and to be brought into exactly fitting contact with the walls of the negative mould;

c) cooling and de-moulding of the moulded glass article.

A basic point of the invention lies in the fact that the glass, which can be present in highly fluid or paste-like form, is, as it were, “sucked into” the negative mould solely as a result of its own weight and the application of negative pressure to the negative mould and is brought into exactly fitting contact with the walls of the negative mould. Because a uniform negative pressure is present within the entirety of the negative mould, occupation of the mould by the liquid or paste-like glass is accomplished uniformly in the entirety of the negative mould, without giving rise to stresses within the glass due to pointwise force application, as would be the case, for example, when using a plunger.

On the contrary, because of the lack of a force that is applied pointwise, the glass can spread out in optimum manner in the negative mould under the influence of the negative pressure that is applied and come into contact with the walls of the negative mould in the thermodynamically most advantageous form. For that reason, the glass of the stopper can solidify in its thermodynamically most advantageous form so that a risk of future stress-related breakage is minimal, especially compared to pressed glass stoppers.

### BRIEF DESCRIPTION OF THE SEVERAL VIEWS OF THE DRAWINGS

FIG. 1 shows a first embodiment of an apparatus according to the invention; and

FIG. 2 shows a detail of the embodiment according to FIG. 1.

### DETAILED DESCRIPTION OF THE INVENTION

Filling the portion units of liquid or paste-like glass into the negative mould of the article to be produced can be carried out by introducing the hot glass in gob form into the negative mould. For that purpose, a supply tube is preferably so dimensioned that, when the requisite amount of glass is sufficient for the portion unit for filling the negative mould, gob separation occurs.

In accordance with a further embodiment, the portion unit of liquid or paste-like glass can be cut off from a thread of liquid or paste-like glass and introduced into the negative mould. It is also possible for the glass to be introduced into the negative mould beforehand and the portion unit cut off subsequently. This is especially advantageous when glass at a lower temperature is used so that it is not highly fluid but, rather, viscous to paste-like.

It should be mentioned at this point that the portion unit can be of such a size that the negative mould is filled out level or still has a remaining upper empty volume. It is furthermore possible, making use of the surface tension of the glass, to introduce an amount of glass into the negative mould such that the portion unit stands somewhat proud of the negative mould without, however, the glass flowing away laterally.

In accordance with the invention, an external surface of the glass located in the negative mould, especially a surface thereof facing an introduction aperture of the negative mould, is heat-treated, for which there is used preferably a burner, especially a blowtorch. This makes it possible to achieve, by means of brief melting of the glass surface, flow and therefore smoothing-out of the glass, so that a perfectly smooth surface with an optically good design is formed. By this means, minor ridges or unevenness can be smoothed out and removed in advantageous and very simple manner.

In accordance with the invention, the negative mould and/or a housing containing the negative mould is/are temperature-adjusted, especially cooled, which is carried out preferably using water. By this means it is ensured that the negative mould and/or the housing containing the negative mould is/are always kept at an optimum process temperature. In accordance with the invention, this process temperature is max. 70° C., preferably in the range between 50° C. and 65° C. The cooling of the housing and/or of the negative mould furthermore ensures that the glass introduced into the negative mould at a temperature in the region of 1100° C. cools down and, as a result, solidifies very rapidly on contact with the walls of the negative mould, whilst glass that is located further away from the walls of the negative mould, that is to say glass that is present in the interior of the glass article being produced, remains plastic somewhat longer owing to the absence of direct contact with the walls of the negative mould and the molecules of that glass mass can orient themselves in the thermodynamically most advantageous manner. Because heat removal occurs most markedly at those locations where there is direct contact with the internal walls of the negative mould, that side of the glass article being moulded which faces the introduction aperture of the negative mould cools down most slowly so that stresses on that side can dissipate until the end and, as previously mentioned, an extremely low-stress glass article is formed.

It should be mentioned that heat treatment of that surface of the glass article which faces towards the introduction aperture of the negative mould can be carried out at the same time as the solidification thereof in the interior of the negative mould. By this means, on the one hand, the heated surface remains plastic for longer so that stresses can dissipate there for longer. On the other hand, the simultaneous heat treatment can result in speeding up of the method for producing the glass articles, because it is possible to dispense with subsequent heat treatment of the cooled article.

In accordance with the invention, for de-moulding, the negative mould is opened, preferably by means of a linear displacement of at least one mould element of mould elements forming the negative mould. Because a glass stopper produced in accordance with the invention has, below its top part, a groove bounded by a ridge, in which groove a seal is fitted after production for closure of a bottle, the opening of the negative mould is necessary for de-moulding of the stopper, this being advantageously carried out by means of a pneumatic cylinder by means of which a linear movement of a mould element forming the negative mould is carried out so that the finished stopper can be removed from the mould. At this point it should be mentioned that a negative mould, for example composed of two mould elements, can be so opened that the two mould elements forming the mould are moved linearly in opposite directions. By this means it is advantageously possible to compensate for a “recoil effect” which would possibly come about in the case of a linear displacement of just one mould element.

In order to assist de-moulding of a finished glass stopper, compressed air can be blown into the negative mould, in which case there is advantageously provided at least one supply line to the negative mould both for applying negative pressure and also for blowing in compressed air. Switching-over from negative pressure to positive pressure, optionally via a non-pressurised state, can be controlled, in accordance with the invention, by means of a valve, advantageously by means of a solenoid valve.

There is furthermore provided, for removing the finished glass article, a suction device, for example in the form of a suction cup, by means of which the glass article can be brought into a cooling region and/or storage region or the like.

Of course, a gripping device can also be used for that purpose instead of a suction device similar to a suction cup.

The problem for the invention is furthermore solved by an apparatus for producing glass articles, especially closure bodies of glass such as, for example, glass stoppers, comprising a housing containing a negative mould for a glass article to be produced, the negative mould being suitable for accommodating liquid or paste-like glass and there being provided at least one line which is in communication with the negative mould and by means of which a predefined fluid pressure, especially negative pressure, can be applied to the negative mould.

As previously mentioned, a basic concept of the invention is that the glass introduced into the negative mould comes into contact with the walls of the negative mould solely by virtue of the applied negative pressure and its own weight. In the process the negative pressure is applied to the negative mould in such a way that a uniform negative pressure acts in the entirety of the negative mould, although it should be emphasised that in accordance with the invention the negative pressure does not have to be applied directly in the immediate interior of the negative mould but can also act on the internal volume thereof by way of defined leakages in the negative mould, in which case the negative pressure also acts in the housing parts surrounding the negative mould. By that means it is possible, for example, for a ridge bounding a groove for a future sealing ring to be formed by liquid glass penetrating into a gap and solidifying inside that gap by virtue of the temperature-adjusted housing, which has a temperature-dissipating effect. As a result of the solidification, the leakage originally made use of is sealed so that subsequently a negative pressure is applied only in the main volume of the negative mould.

In accordance with the invention there is provided at least one solenoid valve by means of which the pressure applied to the negative mould can be switched over from a system for producing negative pressure, optionally via a non-pressurised state, to a system for producing positive pressure, and vice-versa.

By that means it is possible for the same lines through which the negative pressure is applied to the negative mould also to be used for directing positive pressure in towards the negative mould, which simplifies de-moulding of the finished glass body.

As previously mentioned, at least the negative mould and/or a housing containing the negative mould is/are constructed to be temperature-adjustable, with cooling to a temperature in the range from 50° C. to max. 70° C. being provided in accordance with the invention. The cooling is carried out, in cost-advantageous manner, with water, although of course other cooling fluids can also be used. Cooling can be carried out by means of cooling tubes which are arranged on or in the housing or by means of a cooling fluid which washes around the housing.

The negative mould can furthermore be opened, preferably by a linear displacement—especially by means of at least one pneumatic cylinder—of at least one mould element of mould elements forming the negative mould, so that glass articles having undercuts in the finished state can also be removed from the negative mould by simple means.

The problem is furthermore solved in accordance with the invention by means of a plant for producing glass articles, especially closure bodies of glass such as, for example, glass stoppers, in which a plurality of apparatuses according to the statements hereinbefore are arranged next to one another and are operable synchronously. By that means it is possible to increase the throughput of such a plant substantially, the apparatuses in the plant advantageously being movably arranged and being displaceable, especially station-wise. By that means it is possible, whilst using just one supply system for the liquid glass, to charge a plurality of apparatuses according to the invention, it being possible for the glass articles being produced to cool down and to be surface-heat-treated during displacement of the apparatuses. In addition, in accordance with the invention, the apparatuses can be so displaced that routes within the production spaces are made shorter, for example by moving the glass-filled apparatuses for de-moulding already into the vicinity of a storage, cooling or onward transportation apparatus.

The problem for the invention is furthermore solved by the use of an above-mentioned apparatus and an above-mentioned plant in the production of glass articles, especially glass stoppers.

The subordinate claims give rise to further embodiments of the invention.

The invention will be described hereinbelow by means of an exemplary embodiment which will be explained in greater detail with reference to the Figures.

In the description that follows, the same reference numerals are used for parts that are identical or that have an identical effect.

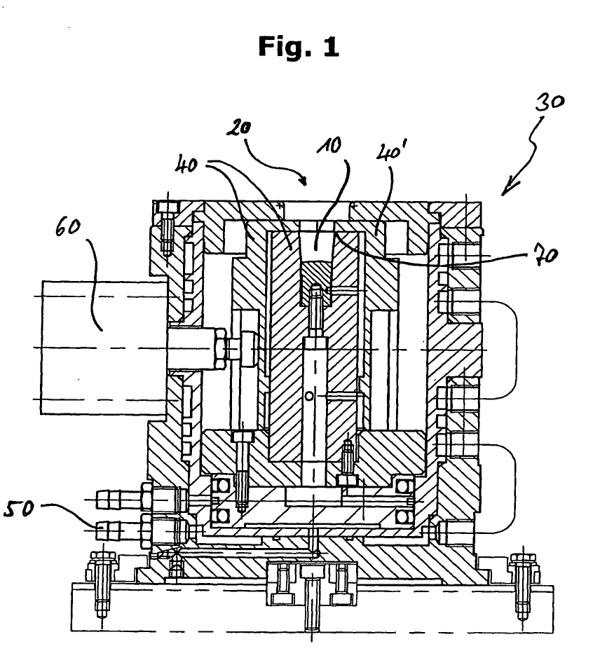

FIG. 1 shows a first embodiment of an apparatus according to the invention, having a negative mould 10, which is arranged in a housing 30. Liquid glass can be introduced into the negative mould through an introduction aperture 20. The Figure furthermore shows mould parts 40, 40′, which can be moved by means of a linear movement that can be accomplished by means of a pneumatic cylinder 60, so that the finished glass article can be de-moulded. Below the negative mould 10 there is a region by way of which a vacuum, or negative pressure, can be applied to the negative mould 10 or the housing 30 by way of the supply line 50.

For the purpose of de-moulding a finished glass article, the mould elements 40, 40′ are moved linearly to the side so that the glass stopper can be removed from the negative mould 10 by means of compressed air and a suction cup. The formation of a ridge 70 is accomplished as a result of the mould elements 40, 40′ forming, by means of their bottom edges 80 adjacent to the negative mould, a gap into which glass can penetrate by way of a defined leakage to an extent determined by tests. As a result of a linear displacement of the mould elements 40, 40′ towards the outside, this ridge 70 is freed for the purpose of de-moulding.

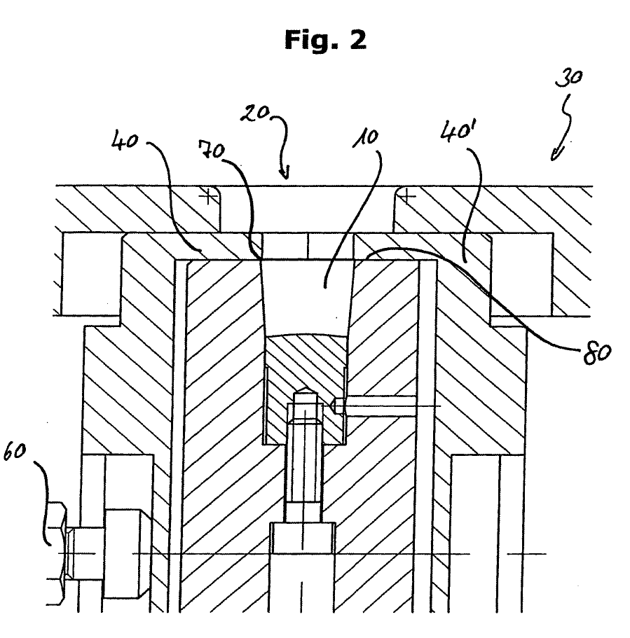

FIG. 2 shows details, to a larger scale, of the apparatus in the region of the negative mould 10.

To summarise, it is to be noted that the invention defines a highly efficient, fast and economical method of producing glass articles such as, for example, glass stoppers, in which, by avoiding contact with a plunger, there can be produced on the one hand a homogeneous and aesthetic glass stopper surface. As a result of the application of negative pressure, moulding of the glass article in conformity with a wide diversity of surface characteristics and negative moulds is possible and, in addition, cleaning and maintenance of the apparatus according to the invention are simplified compared to apparatuses according to the prior art by virtue of a substantially simpler structure and design of the apparatus according to the invention, the maintenance intervals of the apparatus according to the invention and resulting from the method according to the invention also being substantially longer than in the prior art.

At this point it should be pointed out that all the above-described parts, considered on their own and in any combination, especially the details shown in the drawings, are claimed as being important to the invention. The person skilled in the art will be familiar with modifications thereto.

### LIST OF REFERENCE NUMERALS

10 negative mould
20 introduction aperture
30 housing
40, 40′ mould elements
50 line
60 pneumatic cylinder
70 ridge
   80 edge

What is claimed is:

1-16. (canceled)

17. A method of producing glass articles wherein the following steps are carried out:
a) introducing a portion unit of liquid or paste-like glass into a negative mould (10) of an article to be produced;
b) applying negative pressure to the negative mould (10) for a period which is sufficient for the liquid or paste-like glass to be sucked into the negative mould (10) and to be brought into exactly fitting contact with the walls of the negative mould (10);
c) cooling and de-moulding of the moulded glass article.

18. The method of claim 17 wherein the glass article is a glass closure for a container.

19. The method according to claim 17, wherein the portion unit of liquid or paste-like glass is introduced in gob form into the negative mould (10).

20. The method according to claim 17, wherein the portion unit of glass is cut off from a thread of liquid or paste-like glass and introduced into the negative mould (10).

21. The method according to claim 17 wherein an external surface of the glass located in the negative mould (10) is heat-treated to smooth the surface.

22. The method according to claim 17 wherein at least one of the negative mould (10) and a housing (30) containing the negative mould (10) is temperature-adjusted.

23. The method according to claim 22 wherein at least one of the negative mould (10) and the housing (30) is water cooled.

24. The method according to claim 17 wherein, for de-moulding, the negative mould (10) is opened by linear displacement of at least one mould element (40) of mould elements (40, 40′) forming the negative mould (10).

25. The method according to claim 17 wherein, for de-moulding, compressed air is blown into the negative mould (10).

26. The method according to claim 17 wherein at least one supply line (50) to the negative mould (10) is provided for applying negative pressure and for blowing in compressed air for positive pressure,

27. The method according to claim 26 switching-over from negative pressure to positive pressure is controlled by a solenoid valve.

28. The method according to claim 17 wherein de-moulding of the glass article is carried out with the aid of a suction device.

29. Apparatus for producing glass articles comprising a housing (30) containing a negative mould (10) for a glass article to be produced, the negative mould (10) being suitable for accommodating liquid or paste-like glass and there being provided at least one line (50) which is in communication with the negative mould (10) through which a predefined fluid pressure can be applied to the negative mould (10).

30. The apparatus according to claim 29 wherein the glass articles are glass closure bodies for containers.

31. The apparatus according to claim 29 wherein at least one solenoid valve is provided controlling pressure applied to the negative mould (10) so it can be switched from a system for producing negative pressure to a system for producing positive pressure.

32. The apparatus according to claim 29 wherein at least one of the negative mould (10) and a housing (30) containing the negative mould (10) is temperature-adjustable by heating or cooling.

33. The apparatus according to claim 32 wherein at least one of the negative mould (10) and the housing (30) is water coolable.

34. The apparatus according to claim 32 wherein the housing (30) contains cooling lines that pass through the housing.

35. The apparatus according to claim 29 wherein the negative mould (10) is arranged to be opened a linear displacement of at least one mould element (40) of mould elements (40, 40′) forming the negative mould (10).

36. The apparatus of claim 35 where a pneumatic cylinder is used to provide the linear displacement.

37. A plant for producing glass articles wherein there are provided a plurality of apparatuses according to claim 29 which are arranged next to one another and are operable synchronously.

38. A plant according to claim 37 wherein the apparatuses in the plant are movably arranged and are relatively displaceable for movement to different stations.
